(19) United States
(12) Patent Application Publication
(10) Pub. No.: US 2009/0236189 A1
(43) Pub. Date: Sep. 24, 2009

(54) Disc Brake, In Particular for a Utility Vehicle

(75) Inventor: Wlodzimierz MACKE, Olching (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 12/394,500

(22) Filed: Feb. 27, 2009

Related U.S. Application Data
(63) Continuation of application No. PCT/EP2007/007443, filed on Aug. 24, 2007.

(30) Foreign Application Priority Data
Aug. 31, 2006 (DE) 10 2006 040 754.7

(51) Int. Cl. F16D 65/18

(52) U.S. Cl. 188/73.43

(57) ABSTRACT

A disc brake, in particular for a commercial vehicle, includes a caliper which engages over a brake disc, and a brake application device, by which a brake pad can be pressed against the brake disc via at least one actuating spindle in the caliper, in correspondence with a pressure piece. The actuating spindle is encased by a deformable bellows between the pressure piece and the caliper, which deformable bellows has, at its end side, an elastic seal which is provided with an inherently rigid support ring and which is held in the manner of a press fit in an outlet opening of the caliper or of a part which is fastened thereto. The bellows is designed such that the support ring and the seal also bear directly and peripherally against the wall of the outlet opening.

### CROSS-REFERENCE TO RELATED APPLICATIONS

This application is a continuation of PCT International Application No. PCT/EP2007/007443, filed Aug. 24, 2007, which claims priority under 35 U.S.C. § 119 to German Patent Application No. DE 10 2006 040 754.7, filed Aug. 31, 2006, the entire disclosures of which are herein expressly incorporated by reference.

### BACKGROUND AND SUMMARY OF THE INVENTION

The invention relates to a disc brake and, in particular, to a disc brake for a commercial or utility vehicle. Such a disc brake includes a caliper which engages over a brake disc and a brake application device with which, via at least one adjusting spindle, which is guided in the caliper, in correspondence with a pressure piece, a brake pad can be pressed against the brake disc.

The basic design of a disc brake of the above-described type is known, for example, from DE 195 15 063 C2. In DE 195 15 063 C2, the application device has two adjusting spindles, which are mounted in a movable fashion in the caliper and which, at their end facing toward the brake disc, support in each case one pressure piece to which is fastened a brake pad that makes contact with the brake disc during operation. Disc brakes are also known in which the pressure pieces are connected in one piece to the corresponding brake pad.

To protect the interior space of the caliper and the adjusting spindles from dirt, the region in which the adjusting spindle emerges out of the caliper, that is to say, the exit opening, is closed off by way of a folded deformable bellows, which is fastened at one side to the adjusting spindle or to the pressure piece and which is connected at the other side to the caliper or to a closure plate which closes off an assembly opening of the caliper. In this respect, the closure plate is an integral part of the caliper.

To fix the deformable bellows to the caliper, the bellows is pressed, in the end region defined by the greatest outer diameter, into the exit opening, with the associated end region of the bellows being embodied as a seal which, like the rest of the bellows, is composed of a deformable, elastic material, usually an elastomer.

To obtain the interference fit, however, a certain degree of rigidity of the seal is necessary, which rigidity is obtained in that an inherently rigid support ring, preferably composed of metal, is integrated in the seal. The support ring is otherwise vulcanized into the seal material such that the seal, which bears against the wall of the exit opening, is formed by the elastomer material which, after the bellows is pressed into the exit opening, ensures the required sealing action but should at the same time also ensure the hold of the fit.

However, elastomers can only be deformed to a small extent without being damaged, such that the restoring forces required for an interference fit are not provided to a satisfactory extent. For this reason, a permanently secure hold of the folded bellows on the caliper is not ensured.

In the event of, in particular, unfavorable friction conditions between the wall of the exit opening and the lateral surface, which forms the fit surface, of the seal, high operational temperatures, material fatigue of the elastomer, vibrations occurring during operation of the utility vehicle or the like, the bellows can slide out of the interference fit, which has indeed occurred frequently in practice.

The invention is therefore based on the object of further developing a disc brake so as to improve its operational reliability, in particular so as to ensure a permanent secure hold of the bellows on the caliper.

According to the invention, a disc brake, in particular for a commercial vehicle, includes a caliper which engages over a brake disc and a brake application device with which, via at least one adjusting spindle, which is guided in the caliper, in correspondence with a pressure piece, a brake pad can be pressed against the brake disc. The adjusting spindle is encased, between the pressure piece and the caliper, by a deformable bellows which has, at an end side, an elastic seal provided with an inherently rigid support ring and held in the manner of an interference fit in an exit opening of the caliper or a part which is fastened thereto. The support ring and the seal otherwise bear directly and peripherally against the wall of the exit opening.

A disc brake designed in this way is distinguished primarily in that its service life is significantly increased, since the elastic region of the seal, specifically the region composed of the elastomer or a rubber, now performs exclusively sealing functions, while the support ring, by way of its contact pressure, permanently ensures a secure hold of the bellows.

Furthermore, particular emphasis should be given to the fact that a folded telescoping bellows designed according to the invention can be produced in a very cost-effective manner, at least in a cost-neutral manner in relation to the previously used bellows. This is achieved, in particular, in that the support ring is, like before, vulcanized into the elastomer, but only in regions, specifically in such a way that the support ring bears peripherally against the wall of the exit opening.

Since the retention of the bellows now takes place virtually exclusively by way of the metallic support ring, the interference fit is significantly less sensitive to the occurring loadings than has hitherto been the case, with the elastic material of the seal having had to perform both the retaining and sealing functions as mentioned.

Here, the selection of the support ring both with regard to the material properties and also with regard to the shape is influenced exclusively with regard to optimizing the retaining action. In contrast, the seal may, for example, be provided with sealing lips, which bear against the wall of the exit opening and which thus form a secure closure forming a permanently acting barrier for dirt and environmental influences.

The problem of material fatigue therefore does not arise, nor do the occurring high temperatures within the disc brake lead to the sealing or retaining action being adversely affected. Occurring vibrations likewise have substantially no effect on the desired functional reliability of the interference fit.

According to one advantageous refinement of the invention, the support ring is arranged on that side of the bellows which faces away from the brake pad, that is to say the seal, which is composed of elastic material and which bears against the wall of the exit opening, closes off the folded bellows with respect to the external environment of the caliper.

It is thereby effectively prevented that the support ring, which is embedded in a protected fashion, is exposed to environmental influences and rusts, as a result of which the retaining action of the support ring would otherwise at least be restricted.

In principle, the new type of connection of the bellows is not restricted to the connection to the caliper or a closure plate. It is also contemplated for a connection of this type to be provided in the connecting region to the pressure piece or the adjusting spindle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a partial illustration of a disc brake in a sectioned plan view;

FIG. 2 shows a partial detail of the disc brake corresponding to the denotation II in FIG. 1;

FIG. 3 shows a detail of the invention, likewise in a partial detail in a sectioned side view;

FIG. 4 shows an enlarged partial detail from the illustration according to FIG. 2; and

FIG. 5 shows the same partial detail, but of a disc brake according to the prior art.

### DETAILED DESCRIPTION OF THE DRAWINGS

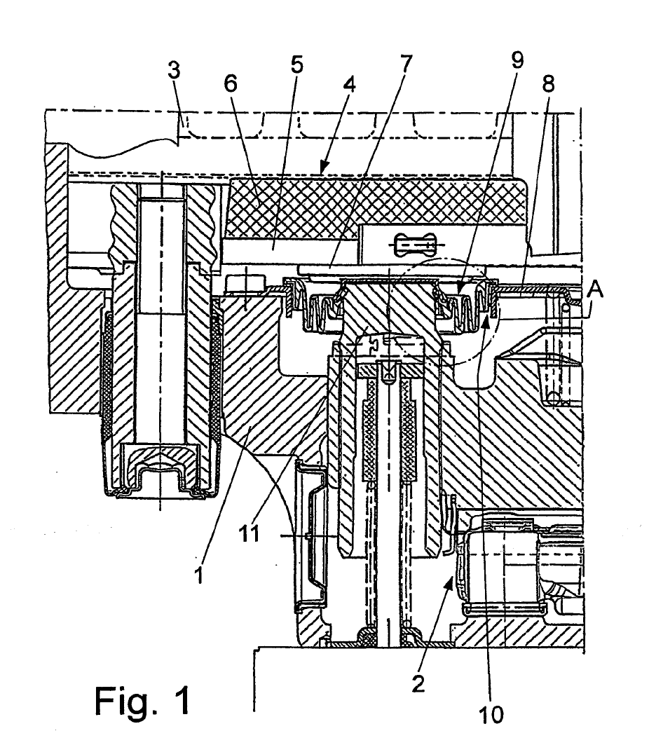

FIG. 1 is a partial illustration of a disc brake, which has a caliper 1 embodied as a sliding caliper. The caliper straddles a brake disc 3 in its upper peripheral region. Here, the disc brake may be actuated pneumatically or by electric motor.

A brake pad 4 is arranged on each side of the brake disc 3, one brake pad 4 being illustrated here. The brake pad 4 can be pressed against the brake disc 3 during operation.

The brake pad 4 is composed of a carrier plate 5, a friction lining material 6 which is fastened to that side of the carrier plate 5 which faces toward the brake disc 3, and two pressure pieces 7 which are connected to the carrier plate 5, one such pressure piece 7 being seen in FIG. 1.

By means of a rotary-lever-actuated application device 2, which is arranged in the caliper 1, an adjusting spindle 11 is pressed against the pressure piece 7 and therefore against the brake pad 4.

To adjust an air play between the friction lining 6 and the brake disc 3, taking into consideration the wear of the friction lining material 6, the adjusting spindle 11, which is designed as a threaded spindle is rotatably mounted in the caliper 1 and can be moved by way of an adjusting device (not illustrated).

In the present exemplary embodiment, the caliper 1 is substantially closed off, on its side facing toward the brake disc 3, by a closure plate 8, which has an aperture in the exit region of the adjusting spindle 11 forming an exit opening 13 there.

To seal off the exit opening 13, a bellows 9 in the form of a convoluted or folded bellows is connected to the closure plate 8, which bellows 9 is rotationally fixedly connected to the closure plate 8 by a seal 10, while the bellows 9 is mounted in a freely rotatable but axially fixed manner on the adjusting spindle 11.

Disc brakes are also known in which the pressure pieces are not, as in the illustrated example, formed in one piece with the carrier plate of the brake pad, but rather are connected to the adjusting spindles. Here, the bellows 9 is usually fixed to the respectively associated pressure piece.

In the case of a single-piece design of the brake caliper 1, that is to say in the event of the closure plate 8 being dispensed with, the bellows 9 is fastened directly to the caliper 1 by being pressed in, as is the case in the example shown, in which the bellows 9 is pressed into the closure plate 8.

FIG. 5 illustrates that end region of the bellows 9 which faces toward the closure plate 8, as is known from the prior art and which forms the seal 10 with which the exit opening 13 is peripherally sealed off.

Here, a support ring 12, which is composed of metal, usually steel, is provided for stiffening the end region which forms the seal 10. The support ring 12 is encased by vulcanization by the seal 10 which is formed from an elastic material, preferably an elastomer or a rubber. Sealing lips 14 are formed on the outer lateral surface of the seal 10, which sealing lips 14 are supported under pressure against the wall of the exit opening 13.

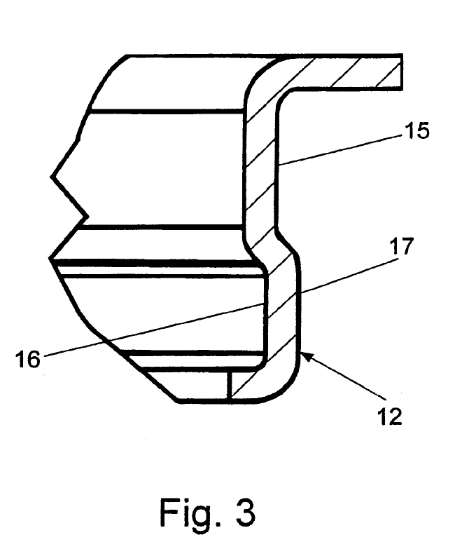

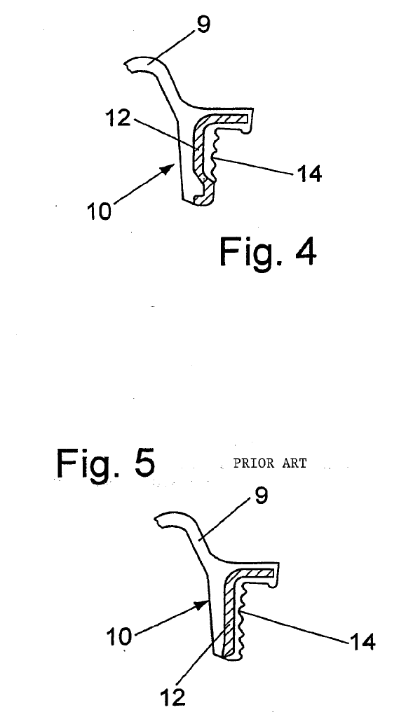

In contrast, according to the invention as can be seen in FIG. 4, the support ring 12 is encased only partially by the seal 10, such that the support ring 12 bears with a pressing surface 17 (FIG. 3) against the wall of the exit opening 13 in the manner of an interference fit.

In the axial direction, toward the outer side of the brake caliper, the seal 10, which is likewise provided with sealing lips 14, likewise bears directly against the wall of the exit opening 13 with a certain degree of deformation of the sealing lips, which deformation serves to ensure effective sealing with respect to the external surroundings.

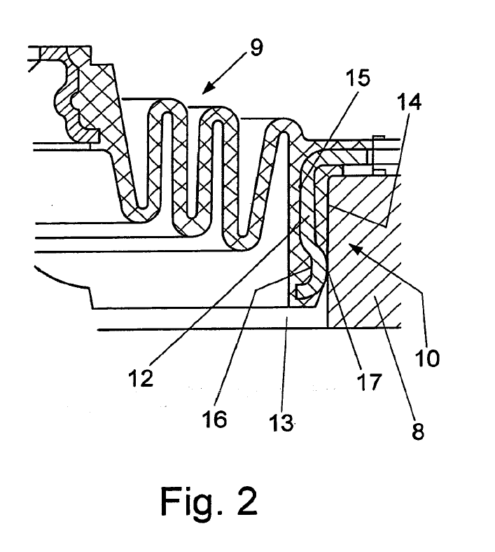

This can be seen in particular in FIGS. 2 and 4.

To obtain a secure connection between the support ring 12 and the elastic material of the seal 10, the support ring 12 has, in each case, one annular groove 15, 16 on the inner and outer lateral surfaces, into which grooves 15, 16 the material of the seal 10 is embedded during the vulcanization process.

The outer diameter, which delimits the pressing surface 17, of the support ring 12 is otherwise slightly larger than the clear diameter of the exit opening 13, such that a sufficient radial contact pressure is obtained, by which the bellows 9 is held securely in the exit opening 13.

### TABLE OF REFERENCE SYMBOLS

1 Brake caliper
2 Application device
3 Brake disc
4 Brake pad
5 Carrier plate
6 Friction lining
7 Pressure piece
8 Closure plate
9 Convoluted bellows
10 Seal
11 Adjusting spindle
12 Support ring
13 Exit opening
14 Sealing lip
15 Groove
16 Groove
17 Pressing surface

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake, having a brake disc, comprising:
a caliper which, in use, straddles the brake disc;
a brake application device for pressing a brake pad via a pressure piece against the brake disc, the brake application device including at least one adjusting spindle guided in the caliper;
a deformable bellows encasing the adjusting spindle between the pressure piece and the caliper, the deformable bellows having, at a radially outer end, an elastic seal;
wherein the elastic seal includes a rigid support ring operatively configured to form an interference fit in an exit opening of the caliper or a part fastened to the caliper which provides the exit opening, both the rigid support ring and the elastic seal bearing directly against a wall of the exit opening about the periphery of the deformable bellows.

2. The disc brake according to claim 1, wherein the support ring comprises an outer peripheral pressing surface, which pressing surface bears under pressure against the wall of the exit opening.

3. The disc brake according to claim 1, wherein the support ring, on both an inner and an outer lateral surface, includes an annular groove into which elastic material of the elastic seal is embedded.

4. The disc brake according to claim 2, wherein the support ring, on both an inner and an outer lateral surface, includes an annular groove into which elastic material of the elastic seal is embedded.

5. The disc brake according to claim 3, wherein the elastic material embedded in the outer annular groove provides a seal region for the elastic seal bearing against the wall of the exit opening.

6. The disc brake according to claim 4, wherein the elastic material embedded in the outer annular groove provides a seal region for the elastic seal bearing against the wall of the exit opening.

7. The disc brake according to claim 5, wherein the seal region includes peripherally arranged sealing lips bearing under deformation against the wall of the exit opening.

8. The disc brake according to claim 2, wherein the pressing surface is arranged on a side of the elastic seal facing away from the bellows.

9. The disc brake according to claim 1, wherein a sealing surface of the electric seal bears against the wall of the exit opening in an axially outer edge region of the wall of the exit opening facing toward the brake pad.

10. The disc brake according to claim 2, wherein an outer diameter of the support ring in a region of the pressing surface is larger than an inner diameter of the exit opening so as to provide the interference fit.

11. The disc brake according to claim 1, wherein the seal comprises one of an elastomer and rubber material.

12. The disc brake according to claim 1, wherein the support ring is made of a metal.

13. The disc brake according to claim 11, wherein the support ring is made of a metal.

14. The disc brake according to claim 13, wherein the support ring is made of steel.

15. The disc brake according to claim 1, wherein the support ring is vulcanized into the elastic seal.

16. The disc brake according to claim 13, wherein the support ring is vulcanized into the elastic seal.

17. A disc brake having a brake disc, comprising:
a caliper having an interior section configured to be sealed off with respect to the brake disc, said section including an exit opening through which a brake application device presses a brake pad against the brake disc via a spindle;
a deformable bellows operatively arranged in the exit opening to seal the interior section of the caliper;
wherein the bellows, on an outer periphery, provides a seal against a wall of the exit opening, the seal comprising an elastic material in which a rigid support ring is arranged, both the elastic material and the support ring bearing directly against the wall of the exit opening.

18. The disc brake according to claim 17, wherein the support ring is configured with a first annular groove formed on an inner lateral surface of the support ring and a second annular groove formed on an outer lateral surface of the support ring, wherein the elastic material which bears directly against the wall of the exit opening is arranged in the second annular groove.

19. The disc brake according to claim 18, wherein the elastic material arranged in the second annular groove includes sealing lips arranged on an outer exterior thereof, which sealing lips deform under pressure against the wall of the exit opening.

20. The disc brake according to claim 18, wherein an outer diameter of the support ring is slightly larger than an inner diameter of the exit opening, such that the support ring bears against the wall of the exit opening with an interference fit.
